(19) United States
(12) Patent Application Publication
(10) Pub. No.: US 2020/0412895 A1
(43) Pub. Date: Dec. 31, 2020

(54) IMAGE READER DEVICE

(71) Applicant: KYOCERA Document Solutions Inc., Osaka (JP)

(72) Inventor: Shigeaki NAKAMURA, Osaka (JP)

(73) Assignee: KYOCERA Document Solutions Inc., Osaka (JP)

(21) Appl. No.: 16/907,939

(22) Filed: Jun. 22, 2020

(30) Foreign Application Priority Data
Jun. 27, 2019 (JP) 2019-119600

(51) Int. Cl. H04N 1/00; H04N 1/028

(52) U.S. Cl. CPC H04N 1/00816; H04N 1/00824; H04N 1/02815; H04N 1/0044

(57) ABSTRACT

An image reader device includes a display unit, a contact glass having a setting surface, an image reader unit, and a control unit. Before the control unit controls the image reader unit to perform normal reading for reading a document area corresponding to a size of the document set on the setting surface, the control unit controls the image reader unit to perform check reading for reading a checking area having a sub-scanning direction length set to a predetermined length smaller than that of the document area, and controls the display unit to display a preview image corresponding to read data of the checking area obtained by the check reading.

### INCORPORATION BY REFERENCE

This application is based upon and claims the benefit of priority from the corresponding Japanese Patent Application No. 2019-119600 filed Jun. 27, 2019, the entire contents of which are hereby incorporated by reference.

### BACKGROUND

The present disclosure relates to an image reader device including a contact glass.

When the image reader device includes the contact glass (document table), a document is set on a setting surface of the contact glass. The image reader device reads the document set on the setting surface. In a copy job, image data for the job is generated based on read data obtained by reading the document. Then, an image based on the image data for the job is printed on a paper sheet.

### SUMMARY

An image reader device according to one aspect of the present disclosure includes a display unit, a contact glass, an image reader unit, and a control unit. The display unit performs displaying. The contact glass has a setting surface on which a document is set. The image reader unit includes a light source that emits light to the document set on the setting surface, an image sensor that receives reflection light reflected by the document so as to read the document, and a moving mechanism that moves the light source in a sub-scanning direction so that a reading line for the image sensor to read is moved in the sub-scanning direction. Before the control unit controls the image reader unit to perform normal reading for reading a document area corresponding to a size of the document set on the setting surface, the control unit controls the image reader unit to perform check reading for reading a checking area having a sub-scanning direction length set to a predetermined length smaller than that of the document area, and controls the display unit to display a preview image corresponding to read data of the checking area obtained by the check reading.

### BRIEF DESCRIPTION OF THE DRAWINGS

FIG. 1 is a schematic diagram illustrating a structure of a multifunction peripheral according to one embodiment of the present disclosure.

FIG. 2 is a diagram illustrating a structure of an image reader unit of the multifunction peripheral according to one embodiment of the present disclosure.

FIG. 3 is a diagram illustrating a setting surface of a contact glass of the multifunction peripheral according to one embodiment of the present disclosure.

FIG. 4 is a diagram illustrating states where a document cover is opened and closed in the multifunction peripheral according to one embodiment of the present disclosure.

FIG. 5 is a block diagram illustrating a structure of the multifunction peripheral according to one embodiment of the present disclosure.

FIG. 6 is a flowchart illustrating a flow of a process performed by a control unit of the multifunction peripheral according to one embodiment of the present disclosure.

FIG. 7 is a diagram illustrating a reading area in check reading performed by the image reader unit of the multifunction peripheral according to one embodiment of the present disclosure.

FIG. 8 is a diagram illustrating a preview image displayed on an operation panel when a document set on the contact glass is inclined in the multifunction peripheral according to one embodiment of the present disclosure.

FIG. 9 is a diagram illustrating a state where a bundle of document sheets is set on the contact glass of the multifunction peripheral according to one embodiment of the present disclosure.

FIG. 10 is a diagram illustrating a state where a bundle of document sheets is set on the contact glass of the multifunction peripheral according to one embodiment of the present disclosure.

FIG. 11 is a diagram illustrating a state where a book document is set on the contact glass of the multifunction peripheral according to one embodiment of the present disclosure.

FIG. 12 is a diagram illustrating a state where a book document is set on the contact glass of the multifunction peripheral according to one embodiment of the present disclosure.

FIG. 13 is a diagram illustrating reading areas of check reading and additional check reading performed by the image reader unit of the multifunction peripheral according to one embodiment of the present disclosure.

FIG. 14 is a diagram illustrating a preview image and an additional preview image displayed on the operation panel of the multifunction peripheral according to one embodiment of the present disclosure.

### DETAILED DESCRIPTION

Hereinafter, there is described an image reader device according to one embodiment of the present disclosure, with an example of a multifunction peripheral having a plurality of functions such as a scan function and a print function.

<Structure of Multifunction Peripheral>

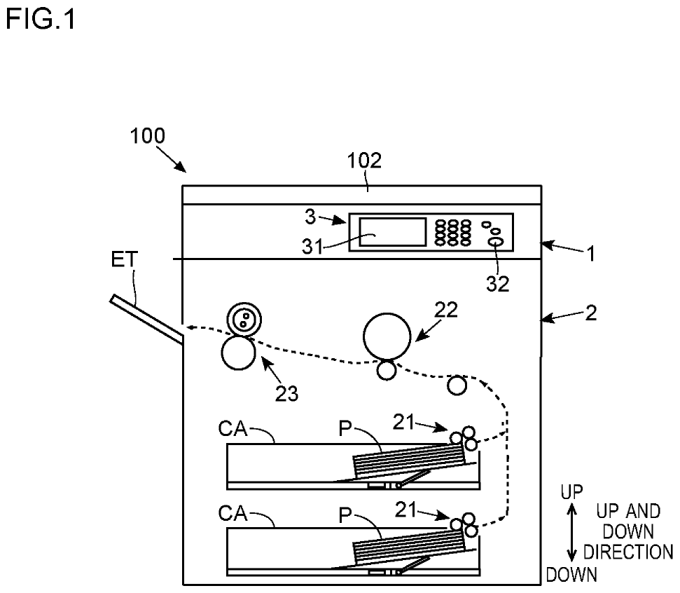

As illustrated in FIG. 1, a multifunction peripheral 100 of this embodiment includes an image reader unit 1 and a printer unit 2. The multifunction peripheral 100 corresponds to the “image reader device”.

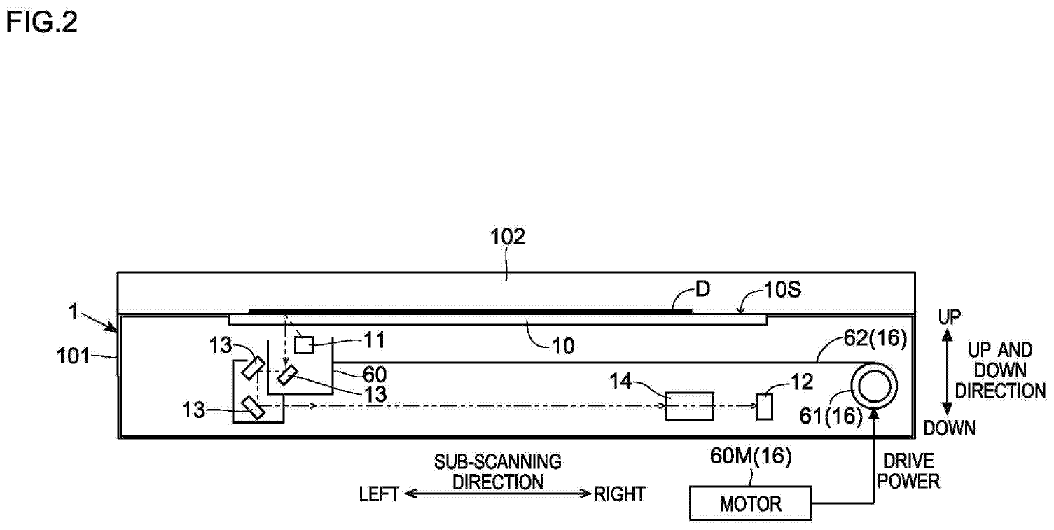

As illustrated in FIG. 2, the image reader unit 1 includes a light source 11, an image sensor 12, a mirror 13 and a lens 14. The light source 11, image sensor 12, the mirror 13, and the lens 14 are disposed inside a casing 101 of the image reader unit 1. A contact glass 10 is attached to an upper part of the casing 101. The upper surface of the contact glass 10 is a setting surface 10S on which a document D is set. The image reader unit 1 reads the document D set on the setting surface 10S.

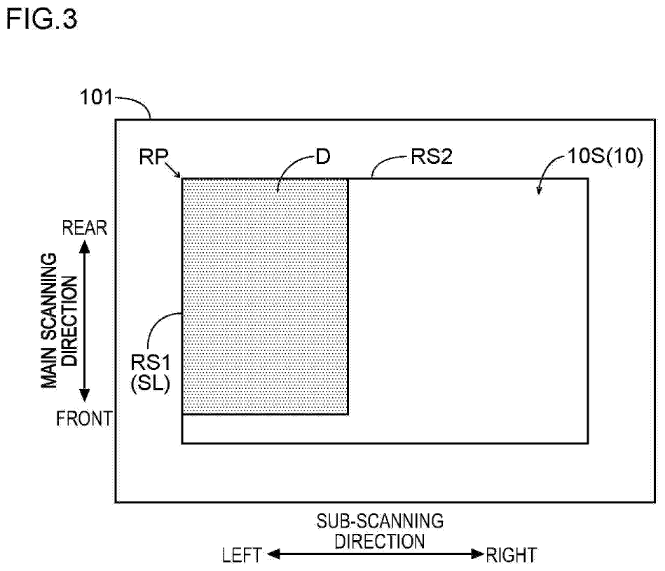

The setting surface 10S has a rectangular shape having long sides in a left and right direction of the device in a plan view as illustrated in FIG. 3. Out of four sides of the setting surface 10S, a pair of short sides is parallel to a main scanning direction (in a front and rear direction of the device), while a pair of long sides is parallel to a sub-scanning direction (a direction perpendicular to the main scanning direction). A size of the setting surface 10S is larger than a maximum document size that can be read by the multifunction peripheral 100 in the specification. Therefore, when the maximum size document D is set on the setting surface 10S, it does not cover the entire setting surface 10S.

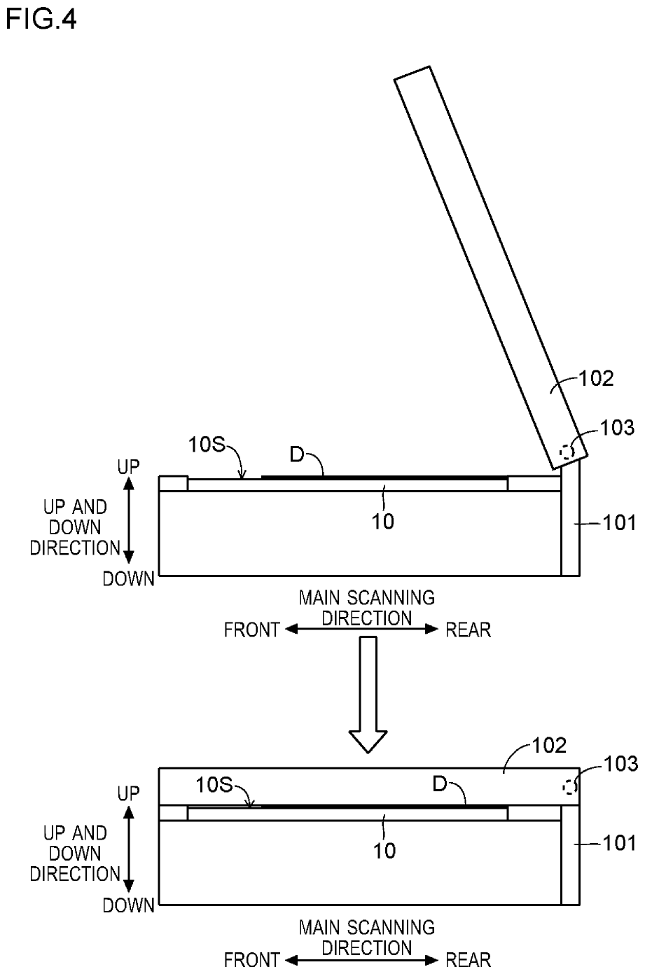

Further, as illustrated in FIG. 4, the casing 101 is provided with a document cover 102. The document cover 102 is opened and closed with respect to the upper surface (the setting surface 10S) of the casing 101. For instance, a pivot shaft 103 is disposed at a rear part of the casing 101. The document cover 102 is supported by the pivot shaft 103 in a rotatable (openable and closable) manner. The document cover 102 has a front part as a free end, and rotates in such a manner that the front part swings up and down. In this way, by lifting up or down the front part of the document cover 102 in the up and down direction, the document cover 102 can be opened or closed with respect to the setting surface 10S.

When the document cover 102 is opened, the setting surface 10S is exposed, and the document D can be set on the setting surface 10S (see the upper part of FIG. 4). When the document cover 102 is closed, the document cover 102 covers the setting surface 10S (see the lower part of FIG. 4). In order to set the document D on the setting surface 10S, a user opens the document cover 102. After setting the document D on the setting surface 10S, the user closes the document cover 102. When the document cover 102 is closed, the document cover 102 presses downward the document D on the setting surface 10S.

With reference to FIG. 2 again, the light source 11 emits light to the contact glass 10 (as shown by a double-dotted dashed line in FIG. 2). The light passes through the contact glass 10 and illuminates the document D on the setting surface 10S. The light source 11 includes a plurality of LED elements. The plurality of LED elements are arranged linearly in the main scanning direction (the direction perpendicular to the paper of FIG. 2). The reflection light reflected by the document D (shown by a double-dotted dashed line in FIG. 2) is reflected by the mirror 13 and is led to the lens 14. The lens 14 focuses the reflection light.

The image sensor 12 receives the reflection light reflected by the document D so as to read the document D. The image sensor 12 includes line sensors corresponding to R, G, and B colors, respectively. The line sensor of each color is constituted of a CCD including a plurality of photoelectric conversion elements aligned linearly in the main scanning direction. When the image sensor 12 receives the reflection light from the document D (the light focused by the lens 14), it performs photoelectric conversion and accumulates its charge for each pixel by line unit. Then, the image sensor 12 outputs an analog signal (RGB signal) corresponding to the accumulated charges.

Further, the image reader unit 1 includes a moving mechanism 16. The moving mechanism 16 moves a carriage 60. The carriage 60 moves in the sub-scanning direction. The carriage 60 holds the light source 11 and the mirror 13.

The moving mechanism 16 includes a motor 60M. Further, the moving mechanism 16 includes a winding drum 61 and a wire 62. The wire 62 is connected to the carriage 60 and the winding drum 61. The winding drum 61 receives drive power from the motor 60M and rotates. When the winding drum 61 rotates, the carriage 60 moves in the sub-s canning direction. In other words, the light source 11 moves in the sub-scanning direction.

When the image reader unit 1 reads the document D, the carriage 60 including the light source 11 moves in the sub-scanning direction (from the left to the right in the device). The light source 11 emits light to the contact glass 10 while the carriage 60 is moving in the sub-scanning direction. As the light source 11 moves in the sub-scanning direction, the reading line of the image sensor 12 moves in the sub-scanning direction. The image sensor 12 performs photoelectric conversion of the reflection light reflected by the document D, continuously and repeatedly. In this way, reading of the document D is performed by line unit.

With reference to FIG. 1 again, the printer unit 2 conveys a paper sheet P along a sheet conveying path (shown by a broken line arrow in FIG. 1). Further, the printer unit 2 forms an image (toner image) to be printed. Then, the printer unit 2 prints (transfers) the image on (to) the paper sheet P being conveyed. In a copy job, the printer unit 2 prints the image of the document D read by the image reader unit 1 on the paper sheet P.

The printer unit 2 includes a sheet feed unit 21, a transfer unit 22, and a fixing unit 23.

The sheet feed unit 21 includes a sheet feed roller. The sheet feed roller pulls out the paper sheet P stored in a paper sheet cassette CA, and feeds the same to the sheet conveying path. Further, the sheet feed unit 21 includes a separating mechanism. The separating mechanism is disposed on a downstream side of the sheet feed roller in a sheet conveying direction. The separating mechanism separates the paper sheets P pulled out from the paper sheet cassette CA one by one.

The transfer unit 22 includes a transfer roller pair. The transfer roller pair includes a photosensitive drum and a transfer roller. The photosensitive drum carries a toner image. The transfer roller is pressed to contact with the photosensitive drum, so as to form a transfer nip between the photosensitive drum and the transfer roller. The transfer roller pair rotates so as to convey the paper sheet P entering the transfer nip while transferring the toner image to the paper sheet P.

Further, the transfer unit 22 includes a charging device, an exposing device, and a developing device. The charging device charges the photosensitive drum. The exposing device forms an electrostatic latent image on the photosensitive drum. The developing device develops the electrostatic latent image into a toner image.

The fixing unit 23 includes a fixing roller pair. The fixing roller pair includes a heating roller and a pressure roller. A heater is embedded in the heating roller. The pressure roller is pressed to contact with the heating roller so that a fixing nip is formed between the heating roller and the pressure roller. The fixing roller pair rotates so as to convey the paper sheet P entering the fixing nip while fixing the transferred toner image on the paper sheet P to the paper sheet P. The paper sheet P after passing through the fixing nip is discharged onto a discharge tray ET.

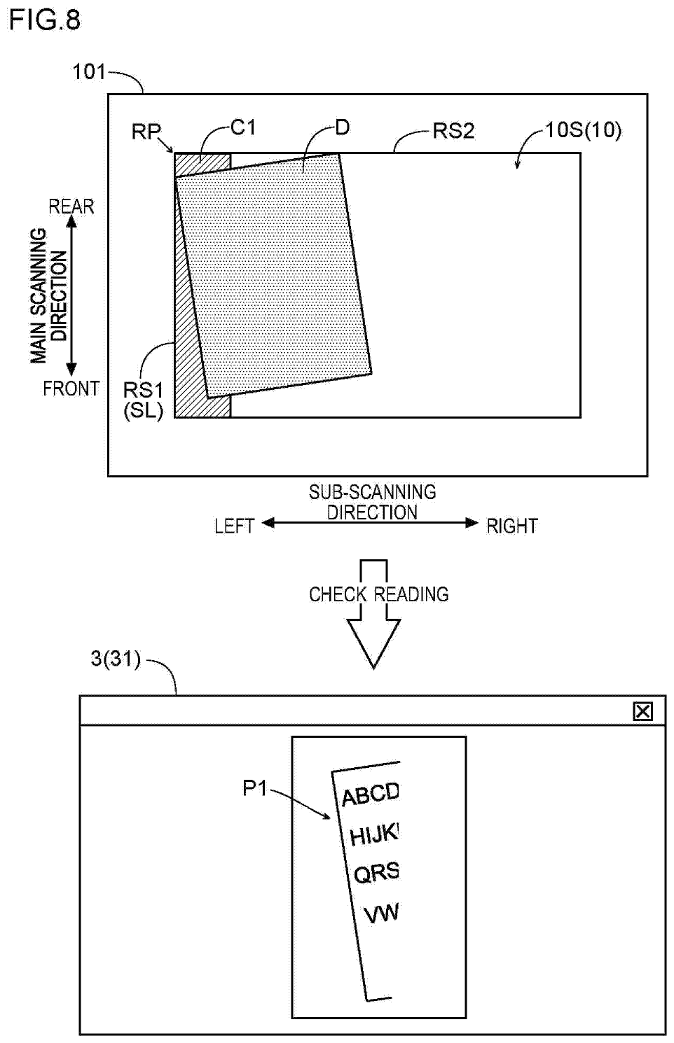

Further, the multifunction peripheral 100 includes an operation panel 3. The operation panel 3 is provided with a touch screen 31. The touch screen 31 includes a display panel and a touch panel. The touch screen 31 displays messages and software buttons, so as to receive a touch operation of the user. Here, the touch screen 31 (the display panel) displays a preview image P1 described later (see the lower part of FIG. 8). In this structure, the touch screen 31 corresponds to a “display unit”.

The operation panel 3 is provided with a start button 32, too. The start button 32 is a hardware button. The start button 32 receives a start operation of the user, which instructs to read the document D. When user makes an operation of pressing the start button 32, this operation is received as the start operation. Note that the operation panel 3 is provided with various hardware buttons other than the start button 32.

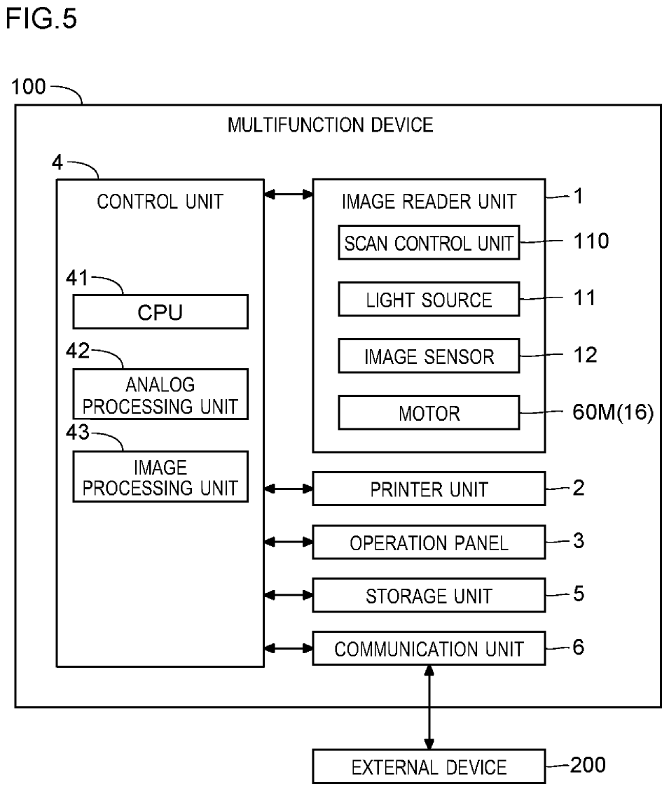

Further, as illustrated in FIG. 5, the multifunction peripheral 100 includes a control unit 4. The control unit 4 controls the image reader unit 1 and the printer unit 2. Further, the control unit 4 is connected to the operation panel 3. The control unit 4 controls a display operation of the touch screen 31 and detects an operation performed to the touch screen 31. In addition, the control unit 4 detects an operation to the hardware button such as the start button 32.

The control unit 4 includes a CPU 41, an analog processing unit 42, and an image processing unit 43. The CPU 41 performs various processing (calculation) based on a program and control data. Further, the CPU 41 gives a control instruction to a scan control unit 110 described later (controls the reading operation of the image reader unit 1).

The analog processing unit 42 includes an amplifier circuit, an A/D conversion circuit, and the like. The analog processing unit 42 converts an analog signal output from the image sensor 12 into digital data (read data). The image processing unit 43 includes an image processing circuit (such as an ASIC). The image processing unit 43 performs image processing on the read data so as to generate job image data (image data to be used for various jobs such as a copy job). Further, the image processing unit 43 performs image processing on the read data, so as to generate display image data (display data of the preview image P1 described later).

The control unit 4 is connected to a storage unit 5. The control unit 4 performs writing of information into the storage unit 5 and reading of information from the storage unit 5. The storage unit 5 includes storage devices such as a ROM, a RAM, and an HDD.

The control unit 4 is connected to a communication unit 6. The communication unit 6 includes a communication circuit. The communication unit 6 is connected to a communication network. The communication network is connected to external devices 200 such as a personal computer, a server, and a facsimile machine. The control unit 4 communicates with the external devices 200 using the communication unit 6. As the multifunction peripheral 100 is connected to the external devices 200 in a communicable manner, the multifunction peripheral 100 can perform a transmission job for sending image data to the external devices 200.

Further, the image reader unit 1 includes the scan control unit 110. The scan control unit 110 includes a scan control circuit (such as a CPU) and a scan memory. The scan control unit 110 is connected to the control unit 4. The scan control unit 110 controls individual portions of the image reader unit 1 on the basis of the control instruction from the control unit 4. The scan control unit 110 controls a light emission operation of the light source 11. The scan control unit 110 controls the reading operation of the image sensor 12. The scan control unit 110 controls the motor 60M (controls the movement of the light source 11 in the sub-scanning direction). Note that it is possible to adopt a configuration in which the control unit 4 directly controls the light source 11, the image sensor 12, and the motor 60M. In this case, the scan control unit 110 can be eliminated.

<Reading of Document>

In a job accompanying reading of the document D, the user sets the document D on the setting surface 10S. A state where the document D is set on the setting surface 10S is illustrated in FIG. 3. In FIG. 3, the document D is shown with a dot pattern. Note that the copy job, the transmission job, and the like correspond to the job accompanying reading of the document D.

After setting the document D on the setting surface 10S, the user presses the start button 32. In other words, the user performs the start operation. When the control unit 4 detects the start operation, it determines that it has received a request to perform the reading job accompanying reading of the document D. When receiving the request to perform the reading job, the control unit 4 controls the image reader unit 1 to perform reading of the document D set on the setting surface 10S (hereinafter referred to as a set document D).

Before controlling the image reader unit 1 to read the set document D, the control unit 4 detects a size of the set document D (a main scanning direction width and a sub-scanning direction length of the set document D). A method for detecting the size of the set document D is not limited particularly.

For instance, the operation panel 3 receives an input of values indicating the size of the set document D. The control unit 4 detects the size of the set document D on the basis of an input values input to the operation panel 3. Note that the input of the size may be received before the document D is set, or it may be received after the document D is set (after the start button 32 is pressed).

When detecting the size of the set document D, the control unit 4 sets a document area, which is an area corresponding to the size of the set document D, as the reading area. In the example illustrated in FIG. 3, the area with a dot pattern is the document area. Then, the control unit 4 controls the image reader unit 1 to read the document area. In the following description, reading of the document area is referred to as normal reading and is discriminated from check reading described later.

Here, as illustrated in FIG. 3, one of a pair of sides facing in the sub-scanning direction (a pair of sides parallel to the main scanning direction) of the setting surface 10S is set as a first reference side RS1, and one of a pair of sides facing in the main scanning direction (a pair of sides parallel to the sub-scanning direction) of the setting surface 10S is set as a second reference side RS2. Further, an intersection between the first reference side RS1 and the second reference side RS2 is set as a reference position RP.

For instance, the left side of the setting surface 10S is set as the first reference side RS1. Further, the upper side of the setting surface 10S is set as the second reference side RS2. In this case, the upper left corner position of the setting surface 10S is the reference position RP.

Further, a line along the first reference side RS1 is set as a read start line SL in the normal reading performed by the image reader unit 1. In other words, when the control unit 4 controls the image reader unit 1 to perform the normal reading, it controls the same to start reading from the read start line SL.

Therefore, when setting the document D on the setting surface 10S, the user adjusts a corner of the document D to the reference position RP. Further, the user adjusts one of four sides of the document D to the first reference side RS1 and adjusts another side to the second reference side RS2. In this way, the set document D is ideally not inclined.

When the image reader unit 1 finishes the normal reading, the control unit 4 generates the job image data based on the read data obtained by the normal reading. Further, if the job to be performed is the copy job, the control unit 4 controls the printer unit 2 to print the image based on the job image data (the image of the set document D) on the paper sheet P. If the job to be performed is the transmission job, the control unit 4 performs transmission of the job image data to the external devices 200 using the communication unit 6.

<Support Function>

When the user closes the document cover 102, the set document D receives wind pressure. In some cases, the set document D may move (e.g., the set document D is lifted). As a result, an improper normal reading may occur in a state where the set document D is inclined (the position of the set document D on the setting surface 10S is deviated from a proper position). Further, for example, if the set document D is a hardcover book document, spread facing pages to be read may be inclined though the book document is set in such a manner that covers (and the spine) thereof are not inclined.

Accordingly, the multifunction peripheral 100 has a support function for supporting a checking operation (an operation performed by the user) for checking whether or not the set document D is inclined. The operation panel 3 receives setting of enable or disable of the support function is from the user. If the support function is set enabled, the control unit 4 performs a supporting process. In this way, an inclination of the set document D can be easily checked.

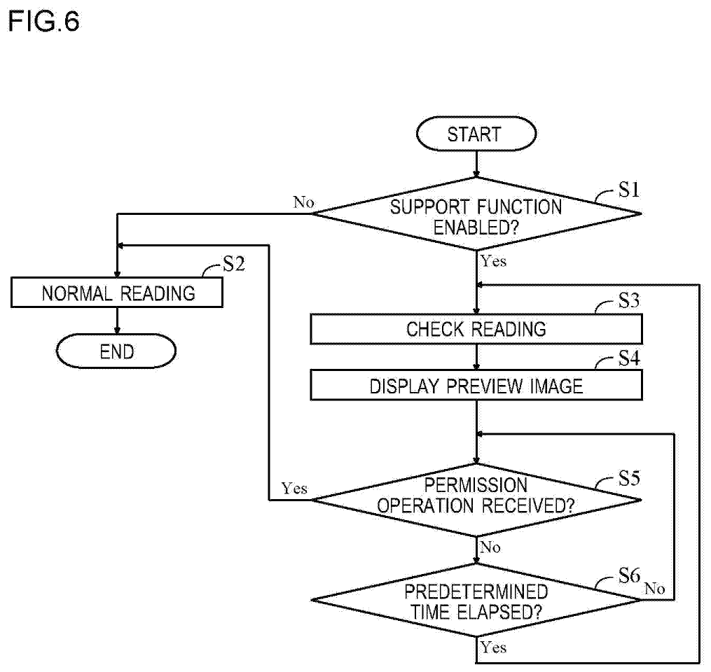

Hereinafter, with reference to a flowchart illustrated in FIG. 6, a flow of the supporting process performed by the control unit 4 is described. The flow of the flowchart illustrated in FIG. 6 starts when the control unit 4 detects that the operation panel 3 has received a first start operation (the operation of pressing the start button 32), after the document D is set on the setting surface 10S.

In Step S1, the control unit 4 determines whether or not the support function is set enabled. If the control unit 4 determines that the support function is set disabled, the process flow proceeds to Step S2. In Step S2, the control unit 4 controls the image reader unit 1 to perform the normal reading.

In Step S1, if the control unit 4 determines that the support function is set enabled, the process flow proceeds to Step S3. In Step S3, the control unit 4 controls the image reader unit 1 to perform the check reading.

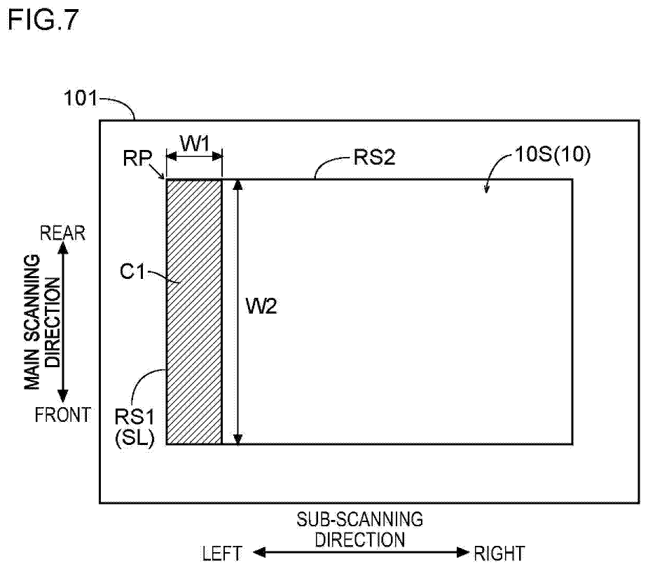

When the control unit 4 controls the image reader unit 1 to perform the check reading, it sets a predetermined checking area C1 as a reading area of the check reading. A position of the checking area C1 in the setting surface 10S is illustrated in FIG. 7. In FIG. 7, the checking area C1 is shown with hatching.

The checking area C1 has a rectangular shape in a plan view. Out of four sides of the checking area C1, one pair of facing sides are parallel to the main scanning direction, and the other pair of sides are parallel to the sub-scanning direction.

A sub-scanning direction length W1 (corresponding to a “predetermined length”) of the checking area C1 is determined in advance and is smaller than a sub-scanning direction length of the document D that can be a reading target. Although not limited particularly, the length W1 of the checking area C1 is ½ or smaller of a sub-scanning direction length of a smallest size out of standard sizes that can be copied by the multifunction peripheral 100. Therefore, the length W1 of the checking area C1 is smaller than the sub-scanning direction length of the set document D (a sub-scanning direction length of the document area). For instance, the length W1 of the checking area C1 is approximately 50 mm.

A main scanning direction width W2 of the checking area C1 is the same as a maximum reading width in the main scanning direction of the image sensor 12. In FIG. 7, for convenience sake, the width W2 of the checking area C1 (the maximum reading width in the main scanning direction of the image sensor 12) is the same as the main scanning direction width of the setting surface 10S, but the maximum reading width in the main scanning direction of the image sensor 12 may be smaller than the main scanning direction width of the setting surface 10S.

Further, when the control unit 4 controls the image reader unit 1 to perform the check reading, it controls the same to start reading from the read start line SL along the first reference side RS1, in the same manner as in the normal reading. In other words, one of a pair of sides facing in the sub-scanning direction of the checking area C1 coincides with the first reference side RS1 (the read start line SL).

In the check reading performed by the image reader unit 1, the checking area C1 having the sub-scanning direction length smaller than that of a reading area of the normal reading (the document area) is read, and other area than the checking area C1 is not read. Therefore, the time from start until completion of the check reading (reading time) is shorter than that of the normal reading.

With reference to FIG. 6 again, after the process of Step S3, the process flow proceeds to Step S4. In Step S4, the control unit 4 generates the preview image P1 corresponding to read data of the checking area C1 obtained by the check reading (see the lower part of FIG. 8). Then, the control unit 4 controls the touch screen 31 to display the preview image P1.

For instance, it is supposed that the user performs the start operation in a state shown in the upper part of FIG. 8 (a state where the set document D is inclined). In this case, the preview image P1 shown in the lower part of FIG. 8 is displayed on the touch screen 31. In this way, the user can easily know a set state of the set document D (an inclination of the set document D). In other words, it can be determined whether or not to reset the document D.

With reference to FIG. 6 again, after the process of Step S4, the process flow proceeds to Step S5. In Step S5, the control unit 4 determines whether or not the operation panel 3 has received a predetermined permission operation. For instance, when the control unit 4 detects that the operation panel 3 has received the start operation (the operation of pressing the start button 32) again after controlling the touch screen 31 to display the preview image P1, it determines that the operation panel 3 has received the permission operation. In this structure, the start button 32 corresponds to an “operation unit”. Note that it may possible that the touch screen 31 displays a permission button (a software button), so that a touch operation to the permission button is received as the permission operation. For instance, the permission button is disposed in the screen including the preview image P1.

In Step S5, if the control unit 4 determines that the permission operation is received, the process flow proceeds to Step S2. In Step S2, the control unit 4 controls the image reader unit 1 to perform the normal reading. In this way, before the image reader unit 1 performs the normal reading, a set state of the set document D can be checked on the basis of the preview image P1. If an inclination of the set document D is beyond a permissible range, the permission operation should not be performed.

In Step S5, if the control unit 4 determines that the permission operation is not received, the process flow proceeds to Step S6. In Step S6, the control unit 4 determines whether or not a predetermined time (e.g. approximately 7 seconds) has elapsed after the preview image P1 is displayed on the touch screen 31. For instance, the time necessary for a reset work (a work performed by the user) for resetting the document D on the setting surface 10S is determined by a manufacturer of the multifunction peripheral 100 and is set as the predetermined time.

In Step S6, if the control unit 4 determines that the predetermined time has not elapsed, the process flow proceeds to Step S5. In other words, if the permission operation is performed before the predetermined time elapses, the image reader unit 1 starts the normal reading.

In Step S6, if the control unit 4 determines that the predetermined time has elapsed, the process flow proceeds to Step S3. When proceeding from Step S6 to Step S3, the control unit 4 controls the image reader unit 1 to perform the check reading again. After that, the process flow proceeds to Step S4. In this case, the control unit 4 controls the touch screen 31 to display the preview image P1 corresponding to the read data of the checking area C1 obtained by the latest check reading, instead of the current preview image P1.

In this way, if the user performs the reset work before the predetermined time elapses, a new preview image P1 indicating a set state of the set document D after the reset work is displayed on the touch screen 31. After that until the user performs the permission operation, the image reader unit 1 performs the check reading every predetermined time, and the preview image P1 corresponding to the read data of the checking area C1 obtained by the latest check reading is displayed on the touch screen 31.

As described above, the multifunction peripheral 100 (the image reader device) of this embodiment includes: the touch screen 31 (display unit) that performs display; the contact glass 10 having the setting surface 10S on which the document D is set; the image reader unit 1 including the light source 11 that emits light to the set document D set on the setting surface 10S, the image sensor 12 that receives reflection light reflected by the set document D so as to read the set document D, the moving mechanism 16 that moves the light source 11 in the sub-scanning direction so as to move the reading line for the image sensor 12 to read in the sub-scanning direction; and the control unit 4. Before the control unit 4 controls the image reader unit 1 to perform the normal reading for reading the document area corresponding to a size of the set document D set on the setting surface 10S, it controls the image reader unit 1 to perform the check reading for reading the checking area C1 having the sub-scanning direction length set to the predetermined length W1 smaller than that of the document area, and controls the touch screen 31 to display the preview image P1 corresponding to the read data of the checking area C1 obtained by the check reading.

In the structure of this embodiment, the check reading is performed before the normal reading. Then, the preview image P1 corresponding to the read data of the checking area C1 obtained by the check reading is displayed on the touch screen 31. In this way, it is possible to allow the user to check a set state of the set document D (an inclination of the set document D) before performing the normal reading. Here, as a result of checking the preview image P1, if an inclination of the set document D is beyond a permissible range, the user performs the reset work. As a result, it is possible to prevent the normal reading from being performed in the state where the set document D is inclined.

Further, the reading area of the check reading (checking area C1) has a sub-scanning direction length smaller than that of the reading area of the normal reading (the document area). In other words, a movement distance in the sub-scanning direction of the carriage 60 (the light source 11) in the check reading is smaller than that in the normal reading. Therefore, the check reading is finished immediately. In this way, the preview image P1 can be displayed in short time (a set state of the set document D can be checked by the user in short time).

Here, in the structure in which the image reader unit 1 performs the check reading, a set state of the set document D (an inclination of the set document D) can be automatically determined on the basis of the read data of the checking area C1 obtained by the check reading. For instance, in the automatic determination process for automatically determine the a state of the set document D, it is determined whether or not the set document D is inclined, on the basis of an inclination of an edge image of the set document D appearing in the read data of the checking area C1.

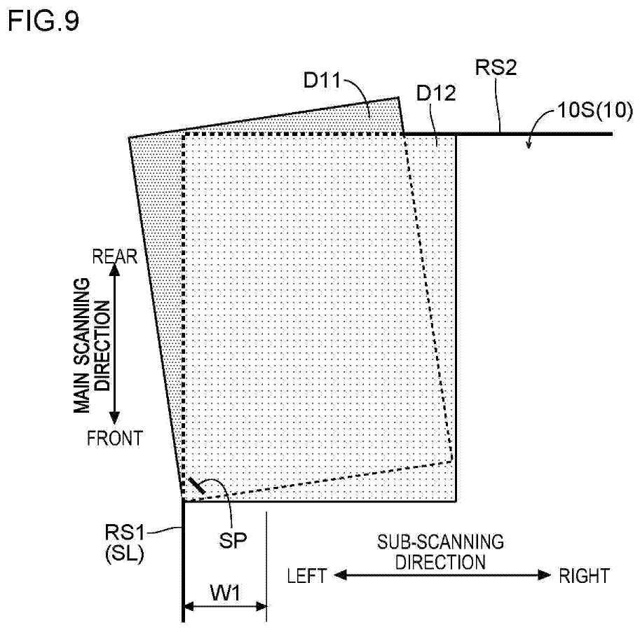

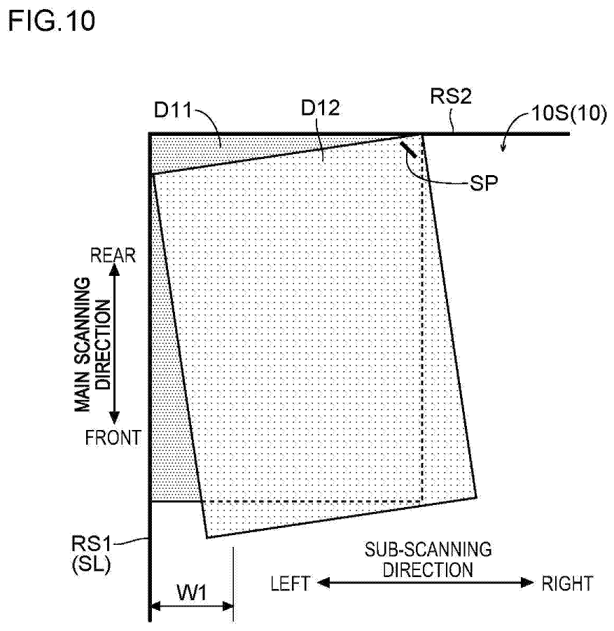

However, if the reading target is a document page of a bundle of stapled document sheets, the following inconvenience occurs. This inconvenience is described below with reference to FIGS. 9 and 10. FIGS. 9 and 10 illustrate cases where there are two pages in the bundle of document sheets, for convenience sake.

In FIGS. 9 and 10, a document page to be read (a document page of the lower side) is denoted by D11, the other document page is denoted by D12, and a stapled part is denoted by SP. Further, the document pages D11 and D12 are shown with dot patterns. In order to easily discriminate between the document pages D11 and D12, dot densities are different between the document pages D11 and D12. In addition, the sides of the setting surface 10S are shown by thick lines.

Note that in the examples shown in FIGS. 9 and 10, the document pages D11 and D12 are overlapped in this order on the setting surface 10S. Accordingly, in FIGS. 9 and 10, a part of the contour of the document page D11 covered by the document page D12 is shown by a broken line.

In the example shown in FIG. 9, the document page D11 (the reading target) protrudes to the outside of the setting surface 10S (the document page D11 is inclined). In other words, a part of a side of the setting surface 10S is covered by the document page D11. In FIG. 9, a part of the sides of the setting surface 10S covered by the document page D11 is shown by a thick broken line.

On the other hand, in the example illustrated in FIG. 9, the document page D2 is not inclined. In other words, one side of the document page D12 parallel to the main scanning direction coincides with the first reference side RS1 (the read start line SL), and another side of the document page D12 parallel to the sub-scanning direction coincides with the second reference side RS2. In this case, an edge image of the document page D12 that is not inclined is detected as a determination target. As a result, in the automatic determination process, it is determined that the reading target is not inclined although the document page D11 is actually inclined.

In the example illustrated in FIG. 10, the document page D11 (the reading target) is not inclined. In other words, one side of the document page D11 parallel to the main scanning direction coincides with the first reference side RS1 (the read start line SL), and another side of the document page D12 parallel to the sub-scanning direction coincides with the second reference side RS2. Therefore, when the normal reading is performed in this state, an output image corresponding to the document page D11 (e.g. an image printed on the paper sheet P) is not inclined.

However, in the example illustrated in FIG. 10, the document page D12 is inclined. In this case, an inclined edge image of the document page D12 appears in the read data of the checking area C1. As a result, in the automatic determination process, it is determined that the reading target is inclined although the document page D11 is actually inclined.

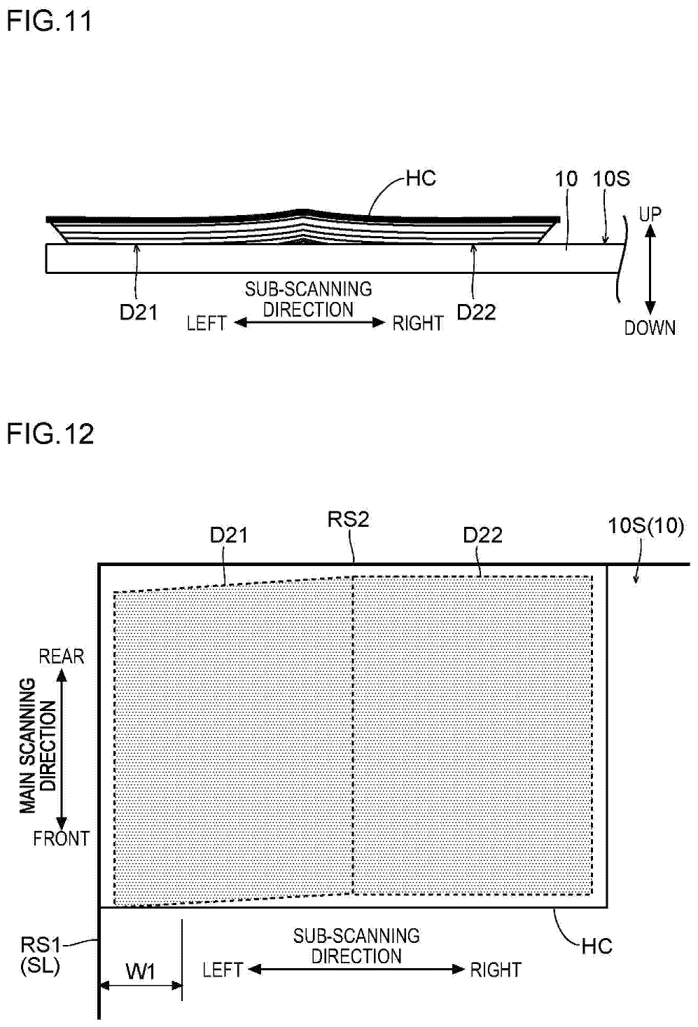

Further, if the reading target is spread facing pages of a book document (e.g. a hardcover book), the following inconvenience occurs. This inconvenience is described below with reference to FIGS. 11 and 12. FIG. 11 illustrates a side view of the book document set on the setting surface 10C, viewed from the front of the device. FIG. 12 illustrates a plan view of the book document set on the setting surface 10C, viewed from above.

In FIGS. 11 and 12, the hardcover is denoted by HC, one page (a left page) of the spread facing pages to be read is denoted by D21, and the other page (a right page) is denoted by D22. Further, in FIG. 12, the pages D21 and D22 are shown with a dot pattern. In addition, sides of the setting surface 10S are shown by thick lines.

Note that in the example illustrated in FIGS. 11 and 12, the pages D21 and D22 are covered by the hardcover HC. Accordingly, in FIG. 12, contours of the pages D21 and D22 are shown by broken lines.

In the example illustrated in FIGS. 11 and 12, the hardcover HC is not inclined. However, the page D21 is inclined within the contour of the hardcover HC (the page D22 is not inclined). In this case, the edge image of the hardcover HC that is not inclined is detected as the determination target. As a result, in the automatic determination process, it is determined that the reading target is not inclined although the document page D21 is actually inclined.

In this way, a determination error may occur in the automatic determination process. Therefore, like the structure of this embodiment, it is preferred to display the preview image P1 so that the user can visually check an inclination of the set document D.

Further, in the structure of this embodiment, as described above, the line along one of a pair of sides facing in the sub-scanning direction of the setting surface 10S (the first reference side RS1) is set as the read start line SL in the normal reading. Further, the control unit 4 controls the image reader unit 1 to start the check reading from the read start line SL. Here, the document D is set on the setting surface 10S normally in such a manner that one side of the document D is along the first reference side RS1. Therefore, by displaying the preview image P1 of the read data obtained by reading a certain number of lines corresponding to the sub-scanning direction length of the checking area C1 from the first reference side RS1 (the read start line SL), the user can check whether or not the set document D is inclined. In this way, it is preferred to control the image reader unit 1 to start the check reading from the read start line SL.

Further, in the structure of this embodiment, as described above, after controlling the touch screen 31 to display the preview image P1, the control unit 4 controls the image reader unit 1 to perform the normal reading when the operation panel 3 receives the permission operation (the operation of pressing the start button 32 again). In other words, after controlling the touch screen 31 to display the preview image P1, the control unit 4 does not control the image reader unit 1 to perform the normal reading until the operation panel 3 receives the permission operation. In this way, it is possible to prevent occurrence of inconvenience that the normal reading starts during the reset work.

Further, in the structure of this embodiment, as described above, after controlling the touch screen 31 to display the preview image P1, the control unit 4 controls the image reader unit 1 to perform the check reading again when the predetermined time has elapsed before the operation panel 3 receives the permission operation (the operation of pressing the start button 32 again), and controls the touch screen 31 to display the preview image P1 corresponding to the read data of the checking area C1 obtained by the latest check reading. In this way, after the reset work, without performing an additional operation instructing to execute the check reading (an operation instructing to display the preview image P1), the preview image P1 indicating the latest set state of the set document D is displayed on the touch screen 31. This is convenient for the user.

Further, in the structure of this embodiment, as described above, after controlling the touch screen 31 to display the preview image P1, the control unit 4 controls the image reader unit 1 to perform the check reading every predetermined time until the operation panel 3 receives the permission operation (the operation of pressing the start button 32 again). In this way, every time when the reset work is performed, the set state of the set document D indicated by the preview image P1 is changed to the latest set state. Therefore, the reset work can be performed efficiently.

The embodiment disclosed in this specification is merely an example in every aspect and should not be interpreted as a limitation. The scope of the present disclosure is defined not by the above description of the embodiment but by the claims, and should be understood to include all modifications within the meaning and scope equivalent to the claims.

For instance, the above embodiment describes the case of performing the check reading for reading only the area of one end side of the set document D in the sub-scanning direction (the read start line SL side), but the present disclosure is not limited to this. In addition to the check reading, it is possible to perform an additional check reading for reading an area of the other end side opposite to the one end side of the set document D in the sub-scanning direction. It may be possible for the user to arbitrarily set whether to perform only the check reading or to perform both the check reading and the additional check reading. The operation panel 3 receives the setting.

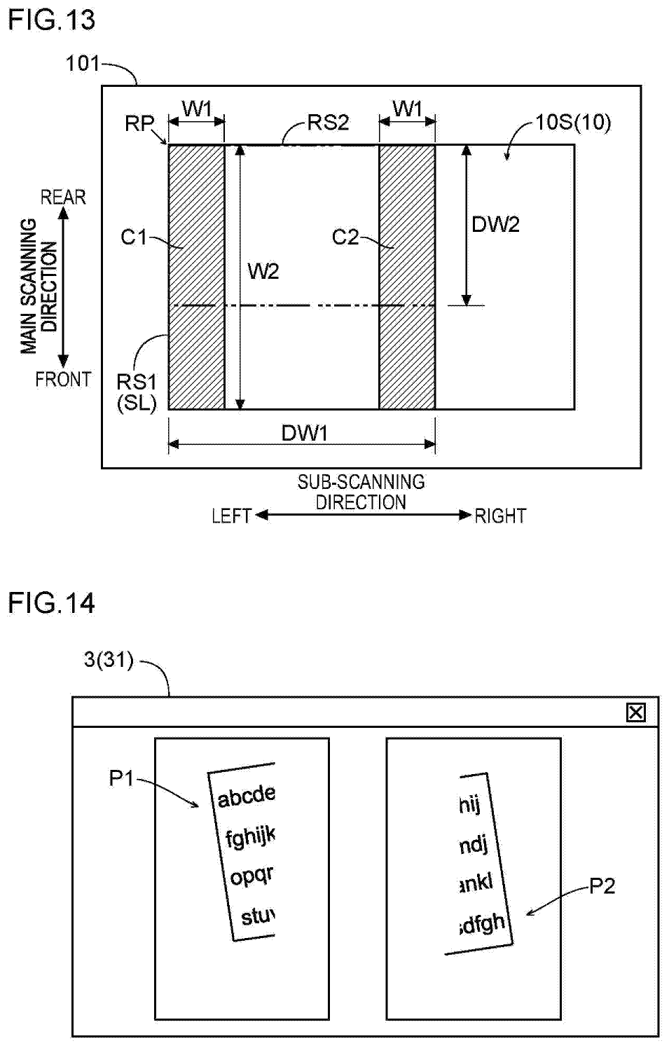

When controlling the image reader unit 1 to perform the additional check reading, the control unit 4 sets a reading area of the additional check reading. One example of the reading area of the additional check reading is illustrated in FIG. 13. In the following description, the reading area of the additional check reading is referred to as an additional checking area and is denoted by C2. Note that in FIG. 13, the document area is shown by a double-dotted dashed line. Further, the sub-scanning direction length of the document area is denoted by DW1, and the main scanning direction width of the document area is denoted by DW2.

A sub-scanning direction length of the additional checking area C2 is equal to the sub-scanning direction length W1 of the checking area C1 (corresponding to the “predetermined length”). In other words, the sub-scanning direction length of the additional checking area C2 is smaller than the sub-scanning direction length of the document D that can be the reading target.

The main scanning direction width of the additional checking area C2 is the same as the main scanning direction width W2 of the checking area C1. In other words, the main scanning direction width of the additional checking area C2 is the same as the maximum reading width of the image sensor 12 in the main scanning direction.

Here, a position of the additional checking area C2 in the sub-scanning direction varies in accordance with a size of the document area (the size of the set document D). For instance, the control unit 4 recognizes a position in the sub-scanning direction of the other side different from the one side along the read start line SL (first reference side RS1), out of a pair of sides facing in the sub-scanning direction of the document area. Further, the control unit 4 sets an area of the predetermined length W1 from the other side toward the read start line SL of the document area, as the additional checking area C2.

Further, before controlling the image reader unit 1 to perform the normal reading, the control unit 4 controls the image reader unit 1 to perform the check reading and the additional check reading. After that, as illustrated in FIG. 14, the control unit 4 controls the touch screen 31 to display the preview image P1 corresponding to the read data of the checking area C1 obtained by the check reading, and an additional preview image P2 corresponding to the read data of the additional checking area C2 obtained by the additional check reading.

In this structure, an inclination of the set document D can be checked at one side and at the other side in the sub-scanning direction, and hence the work of checking an inclination of the set document D can be efficiently performed. For instance, in the example shown in FIGS. 11 and 12, if the page D22 is inclined, the inclination of the page D22 can be known.

What is claimed is:

1. An image reader device comprising:
a display unit for performing displaying;
a contact glass having a setting surface on which a document is set;
an image reader unit including a light source for emitting light to the document set on the setting surface, an image sensor for receiving reflection light reflected by the document so as to read the document, and a moving mechanism for moving the light source in a sub-scanning direction so that a reading line for the image sensor to read is moved in the sub-scanning direction, and
a control unit, wherein
before controlling the image reader unit to perform normal reading for reading a document area corresponding to a size of the document set on the setting surface, the control unit controls the image reader unit to perform check reading for reading a checking area having a sub-scanning direction length set to a predetermined length smaller than that of the document area, and controls the display unit to display a preview image corresponding to read data of the checking area obtained by the check reading.

2. The image reader device according to claim 1, wherein
a line along one of a pair of sides facing in the sub-scanning direction of the setting surface is set as a read start line in the normal reading; and
the control unit controls the image reader unit to start the check reading from the read start line.

3. The image reader device according to claim 1, further comprising:
an operation unit for receiving a predetermined permission operation, wherein
when the operation unit receives the permission operation after the control unit controls the display unit to display the preview image, the control unit controls the image reader unit to perform the normal reading.

4. The image reader device according to claim 3, wherein when a predetermined time has elapsed before the operation unit receives the permission operation after the control unit controls the display unit to display the preview image, the control unit controls the image reader unit to perform the check reading again, and controls the display unit to display the preview image corresponding to read data of the checking area obtained by the latest check reading.

5. The image reader device according to claim 4, wherein after the control unit controls the display unit to display the preview image until the operation unit receives the permission operation, the control unit controls the image reader unit to perform the check reading every predetermined time.

6. The image reader device according to claim 1, wherein
one of a pair of sides facing in the sub-scanning direction of the document area is along a read start line,
the control unit sets an area of the predetermined length from the side other than the one of a pair of sides facing in the sub-scanning direction of the document area toward the read start line, as an additional checking area, and
before controlling the image reader unit to perform the normal reading, the control unit controls the image reader unit to perform the check reading and additional check reading for reading the additional checking area, and controls the display unit to display the preview image and an additional preview image corresponding to read data of the additional checking area obtained by the additional check reading.
